(19) United States
(12) Patent Application Publication
(10) Pub. No.: US 2024/0245045 A1
(43) Pub. Date: Jul. 25, 2024

(54) APPARATUS AND METHOD WITH DYNAMIC INTERFACE FOR MECHANICAL, SELECTIVE WEED CONTROL IN CROPS INCLUDING TURFGRASSES

(71) Applicant: SWARD LLC, South Glastonbury, CT (US)

(72) Inventor: Jason Jeffrey HENDERSON, South Glastonbury, CT (US)

(21) Appl. No.: 18/562,453

(22) PCT Filed: May 23, 2022
(86) PCT No.: PCT/US2022/030531

§ 371 Date: Nov. 20, 2023

Related U.S. Application Data
(60) Provisional application No. 63/191,725, filed on May 21, 2021.

(51) Int. Cl. A01M 21/02; A01D 34/42; A01D 34/62

(52) U.S. Cl. CPC A01M 21/02; A01D 34/42; A01D 34/62

(57) ABSTRACT

An apparatus comprising a blade carrier rotatably attached to the apparatus and having a first longitudinal axis and comprising blades disposed around the first longitudinal axis, extending radially therefrom and defining a first cylindrical diameter; a brush rotatably attached to the apparatus and having a second longitudinal axis, the brush further comprising a plurality of bristles extending outwardly from the second longitudinal axis and defining a second cylindrical diameter, the brush being attached to the apparatus such that the second longitudinal axis is substantially parallel to the first longitudinal axis and; and an elevation device for maintaining the blade carrier and brush at a height over a surface to engage desirable and undesirable plants. The blades may be discs or helical blades. The brush and blade carrier are also arranged such that the bristles of the brush engage the blades of the blade carrier

### CROSS-REFERENCE TO RELATED APPLICATIONS

This application claims benefit of U.S. Provisional application 63/191,725, filed May 21, 2021, entitled “APPARATUS AND METHOD WITH DYNAMIC INTERFACE FOR MECHANICAL, SELECTIVE WEED CONTROL IN CROPS INCLUDING TURFGRASSES,” which is hereby incorporated by reference.

### FIELD OF THE INVENTION

The present invention relates to an apparatus useful in reducing weed pressure and/or improving wear tolerance in crops. For example, an apparatus, system and method is provided to improve turfgrass quality, wear tolerance, reduce weed pressure, and for retaining more turfgrass cover when a turfgrass area is subjected to traffic.

### BACKGROUND OF THE INVENTION

As used herein, the term “crop” refers to desirable plants, including, in one aspect of the invention, turfgrasses. Turfgrasses are different from other grasses in three primary ways: turfgrasses can form a dense contiguous community, tolerate frequent mowing and tolerate traffic. Due to these unique qualities turfgrasses are used extensively in our urban culture including golf courses, athletic fields, parks, cemeteries, roadsides and home lawns. Proper turfgrass management is critical to its long-term sustainability and the safety of the playing surfaces where it's utilized. Turfgrass is managed according to five primary cultural practices; 1) mowing, 2) fertilization. 3) cultivation, 4) irrigation and 5) pest control.

While turfgrasses are often grown as part of an athletic field, golf courses and/or lawns, other types of grasses may also comprise a desirable crop plant. For example, grasses may be grown for grazing by cattle. Such grasses may comprise forage grasses, turfgrasses, or a combination thereof. Another example of a crop that may also be grown for harvest is hay.

Pest control employs preventative and/or curative approaches to protecting desirable crop species, such as grasses, from potentially damaging weeds, insects, and/or diseases, Traditionally, turfgrass managers have implemented an Integrated Pest Management (IPM) program to maintain pest populations below threshold levels. The IPM approach allows the judicious use of pesticides to maintain pest populations at an acceptable level to maintain a healthy turfgrass stand. A pesticide is a broad term used to describe any substance that prevents, destroys, repels or mitigates any pest, Pesticides are further categorized according to their intended targets (i.e. herbicides, fungicides, insecticides, etc.). Herbicides, pesticides targeting weeds only, accounted for the highest usage of pesticides in the non-agricultural sectors. This includes home and garden and industrial/commercial/government sectors with a total of 54 million pounds of active ingredient applied in 2012 (U.S. Environmental Protection Agency, Pesticides Industry Sales and Usage 2008-2012 Market Estimates).

The concern regarding pesticide applications has increased tremendously, particularly where there is potential risk of exposure to children such as lawn areas, athletic fields and parks/playgrounds. The primary concern regarding low, nonacute, repetitive and combined exposures are increased risk of cancer, abnormal neurodevelopment, asthma, perturbation of gestational growth, and endocrine-mimicking effects (US AAP 2012 and Can Fam Phys, 2007). J. R. Roberts, C. J. Karr, Pesticide Exposure in Children, Pediatrics Vol. 130, No. 6 (2012); K. L. Bassil, et al, Cancer Health Effects of Pesticides, Canadian Family Physician, Vol. 53 (2007). These very serious concerns have resulted in pesticide restrictions related to athletic fields in 41 out of 50 states, according to the Sports Turf Managers Association. Connecticut has banned all pesticide applications on school grounds and athletic fields serving grades pre-k through grade 8. There is discussion to expand the scope of this law to high school and public grounds. The state of New York passed the Childs Safe Playing Field Act that essentially bans pesticide use on school grounds, day care centers and athletic fields through grade 12. Additionally, several municipalities across the U.S. have banned pesticides on parks, open space parcels and public rights of way. Concerns regarding pesticide impacts on human health and the environment have even advanced to the university and college level where some campuses or specific areas of campus have been declared pesticide-free as they embrace more sustainable approaches.

Turfgrass breeding efforts have resulted in improved cultivars of different turfgrass species that have better insect and disease resistance helping to reduce the susceptibility of some turfgrass species. Additionally, entomopathogenic nematodes have been shown to biologically control some of the most damaging root feeding insects. See. Georgis, R., and R. Gaugler, Predictability in biological control using entomopathogenic nematodes. J. Econ. Entomol. 84(3): p. 713-720. However, many high quality turfgrass areas remain susceptible to weed infestations on a perennial basis. This is particularly a concern in high traffic areas such as athletic fields where turfgrass cover is continually reduced and opportunistic weeds are able to germinate, develop quickly, and potentially dominate a turfgrass stand in a very short period of time.

Previous research has investigated the effects of utilizing existing equipment such as spring-tine harrows or vertical cutting units to damage weeds and create a competitive advantage for turfgrasses on football pitches (Larsen. S. V., P. Kristoffersen, and J. Fischer, Turfgrass management and weed control without pesticides on football pitches in Denmark. Pest Manage. Sci. 60(6): p. 579-587). However, these methods were thought to be too injurious to the established turfgrass resulting in modest weed control and sometimes increased weed pressure. The inventor of the present invention has previously invented a mechanical apparatus for controlling weeds and improving wear tolerance involving a combination of a rotating brush and a fixed, grooved base blade. See, for example, U.S. Pat. Nos. 9,648,863 and 10,194,649, the disclosures of which are incorporated by reference. The inventions disclosed therein are advantageously effective against broadleaf weeds. However, a need still exists for an apparatus that is more effective against narrow leaf weeds, such as crabgrasses.

Accordingly, there is a need for an apparatus, system and method of growing and improving desirable, wear-tolerant plants and reducing undesirable weeds that may compete with this growth. There is further a need for an apparatus, system and method of reducing weeds in turfgrass and other crops without the application of selective herbicides or at least greatly reducing the application of selective herbicides. There is also a need for an apparatus, system and method of producing improved wear tolerance in turfgrass.

### SUMMARY

The novel apparatus disclosed herein enables better selective mechanical pressure to low-lying undesirable plants such as crabgrasses. This is accomplished by the following: fixed base blade elimination, and posterior position of an auger or disced blade carrier in relation to the brush in the direction of travel to enable lower heights of operation. Additionally, hook features on the tips of the auger blades or discs help with penetrating mixed stands (turfgrasses/weeds) and burrs/barbs on the side of the blades or discs interact with the brush to assist with lifting plant material into the brush/blade interface as well as help pull out unwanted plant material.

An apparatus for providing selective tearing, cutting, pulling and or removal of undesirable plants with a dynamic brush/blade interface without substantially damaging desirable plants is provided. In various embodiments of the invention, the apparatus comprises a blade carrier rotatably attached to the apparatus and having a first longitudinal axis, the blade carrier further comprising one or more blades disposed around the first longitudinal axis, extending radially therefrom and defining a first cylindrical diameter; a brush rotatably attached to the apparatus and having a second longitudinal axis, the brush further comprising a plurality of bristles extending outwardly from the second longitudinal axis and defining a second cylindrical diameter, the brush being attached to the apparatus such that the second longitudinal axis is substantially parallel to the first longitudinal axis and; and an elevation device for maintaining the blade carrier and brush at a height over a surface to engage desirable and undesirable plants. In some embodiments the blades or discs are helical. The brush and blade carrier are also arranged such that the bristles of the brush engage the blades of the blade carrier in a dynamic interface and such that the brush and blade carrier are at approximately the same height above the surface, or touch the surface at approximately the same time when lowered by the elevation device. In one example, this relationship is defined by tangents of downward extending radii of each of the first and second cylindrical diameters are approximately level with each other. In another example, the tangent of the blade carrier is lower than the tangent of the brush.

In one example, the blade carrier and the brush are powered to rotate in opposite directions. The spacing between the brush and blade carrier may be adjustable to increase or decrease the size of the dynamic interface. In one example, the dynamic interface does not have any fixed components that directly engage in pulling, tearing, or otherwise damaging undesirable plants or weed.

The blade carrier may further comprise a first helical blade defining the first cylindrical diameter and a second helical blade defining a third cylindrical diameter, wherein the first and third cylindrical diameters are different. The spacing of the brush and blade carrier may be adjustable to engage one or both of the first and second helical blades. The blade carrier blades may further comprise discontinuities, such as hooks on the periphery of one or more blade carrier blades. The blades may be of different sizes. The blades may further comprise burrs/barbs on the sides of the blades. Additionally, spaces on the axle of the blade carrier between the blades may contain surface irregularities to assist with grabbing plant material to help with uprooting or defoliating undesirable plant material.

In another example, the blade carrier having helical blades is replaced by an blade carrier having non-helical blades, such as a roller having a plurality of discs oriented substantially perpendicular to a lengthwise direction of the roller. The disc blades and/or roller may include the same hooks and/or barbs as described with respect to the helical-bladed, auger-type blade carrier.

### BRIEF DESCRIPTION OF THE DRAWINGS

FIG. 1a is a front perspective view including an embodiment of the present invention attached to a ride on mower.

FIG. 1b is a rear perspective view including an embodiment of the present invention attached to a ride on mower.

FIG. 2a is a diagrammatical end view of a brush and blade carrier relationship according to one aspect of the invention.

FIG. 2b is a diagrammatical end view of a brush and blade carrier relationship according to another aspect of the invention.

FIG. 3 is a side view of an auger-type blade carrier according to another aspect of the invention.

FIG. 4 is a perspective view of the auger of FIG. 3.

FIG. 5 is a side view of another auger-type blade carrier according to another aspect of the invention.

FIG. 6 is an end view of an auger-type blade carrier according to another aspect of the invention.

FIG. 7 is an illustration of a nonhelical, disc-type blade carrier according to another aspect of the invention.

### DESCRIPTION OF THE EMBODIMENTS

While the invention has been described in detail with respect to the preferred embodiments thereof, it will be appreciated that upon reading and understanding of the foregoing, certain variations to the preferred embodiments will become apparent, which variations are nonetheless within the spirit and scope of the invention.

The terms “a” or “an”, as used herein, are defined as one or more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not r-necessarily mechanically. The term “or” as used herein is to be interpreted as an inclusive or meaning any one or any combination.

Reference throughout this document to “some embodiments”, “one embodiment”. “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The drawings featured in the figures are provided for the purposes of illustrating some embodiments of the present invention, and are not to be considered as limitation thereto.

As used herein, the term “crop” refers to desirable plants, including desirable grasses, including, but not limited to Kentucky bluegrass, perennial ryegrass and combinations thereof, forage grasses, hay, etc. The term “weed” refers to undesirable perennial, biennial and/or annual plants, including broadleaf (dicotyledonous) and grassy (monocotyledonous) species. As used herein the term “traffic” refers to a combination of wear (i.e. tearing and bruising of leaf tissue) and soil compaction (i.e. forcing soil solids closer together) of the turfgrass system. As used herein the term “wear tolerance” refers to the ability of plants, including but not limited to desirable grasses, to withstand aggregate, repeated stresses of damage to above ground plant material over a period of time.

As is illustrated in the accompanying drawings, an example of the present invention is generally shown as apparatus 100 for operating on desirable turfgrasses and undesirable weeds. In particular, the present invention provides an apparatus, system and method of reducing weed pressure on desirable turfgrasses. Apparatus 100 has a rotating cylindrical brush 110; a rotating blade carrier 120 having one or more helical screw blades 122, and a roller 130. As described in more detail below, the brush and blade carrier are arranged to provide a dynamic interface 115 between the components that rips or pulls at undesirable plants, especially low-lying undesirable plants.

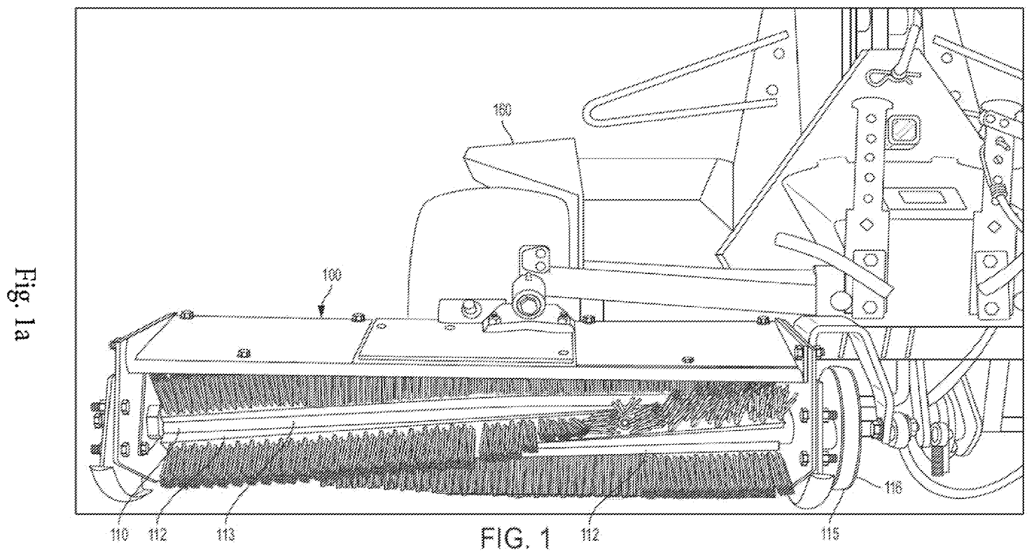

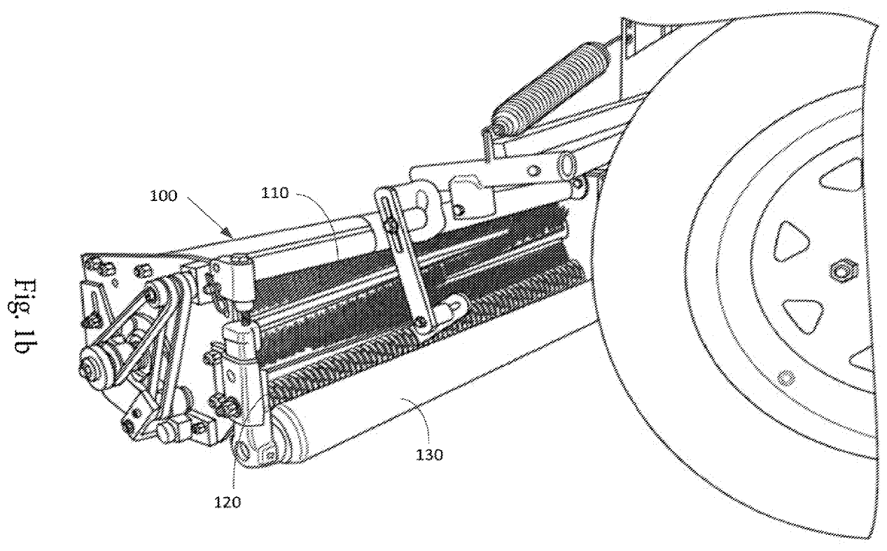

In one example, as illustrated in FIG. 1a, the apparatus 100 is installed on a ride on mower 160, which provides power to rotate the cylindrical brush 110 and blade carrier 120, and propel the apparatus 100 across a surface, such as an athletic field. Roller 130 provides variable height of operation and maintains a desired height 140 of the brush 110 and blade carrier 120 above the ground during operation. Other elevation devices may also be used, including wheels, skids, segmented rollers, and combinations thereof. It is preferable, but not necessarily required, for the elevation device to include a mechanism for adjusting the height of the brush and blade carrier interface relative to the ground. In the illustrated example, the roller is located behind the brush and blade carrier in the predominant direction of travel. In other examples, the roller is located ahead of the blade carrier and brush in the predominant direction of travel. In some examples, direction of travel is reversed, also reversing where the roller is located relative to the blade carrier and brush in the direction of travel.

Brush 110 and blade carrier 120 each have a longitudinal axis. Also, brush 110 and blade carrier 120 each have an outer cylindrical diameter. In the illustrated example, the cylindrical diameter of the blade carrier 120 is smaller than the cylindrical diameter of the brush 110. Other relative diameters may be employed without departing from the scope of the invention. In the illustrated example, the blade carrier is located behind brush in the predominant direction of travel. In other examples, the blade carrier is located ahead of the brush in the predominant direction of travel. In some examples, direction of travel is reversed, also reversing where the blade carrier is located relative to the brush in the direction of travel.

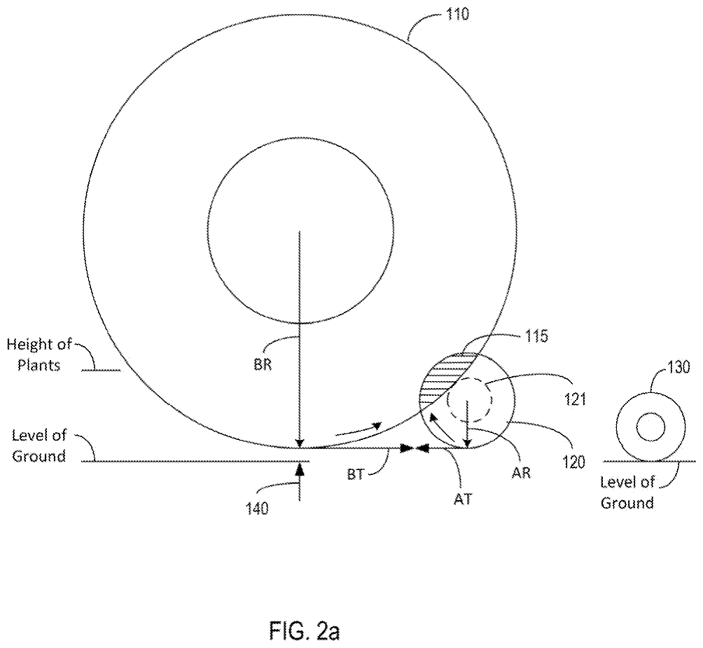

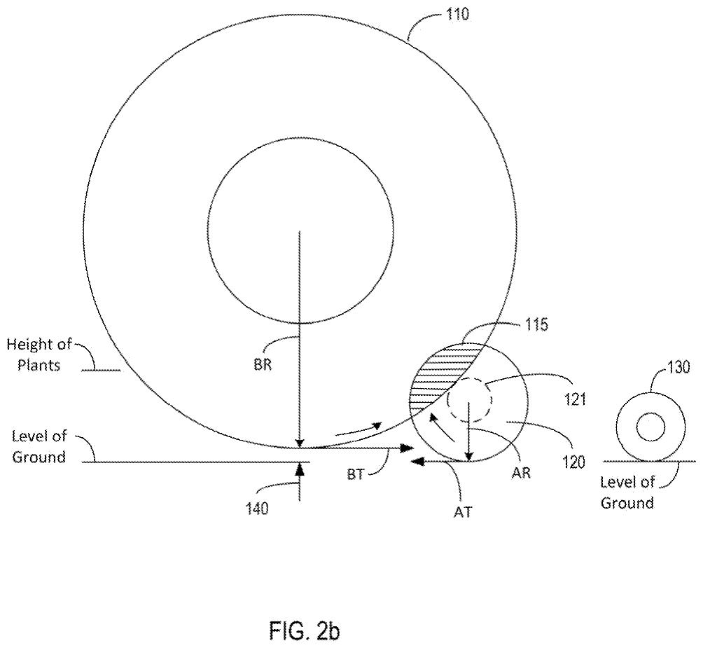

The brush 110 and blade carrier 120 are arranged horizontally relative to the ground (e.g., parallel to the ground) and such that their respective axes are parallel to each other and the bristles of the brush engage with the blades 122 of the blade carrier 120 and/or with an axle 121 of the blade carrier. The brush 110 and blade carrier 120 are rotated such that the engagement between the bristles, blades 122 and/or axle provide a dynamic interface 115. The axle 121 may contain features similar to grooves, however, because the blade carrier rotates, there are no stationary, fixed grooves in the dynamic interface 115. A mechanism is included to adjust the distance between the brush and blade carrier. In one example, the brush and the blade carrier are powered to rotate in a direction counter to each other as indicated by arrows in FIGS. 2a and 2b. In a preferred embodiment, the brush and blade carrier are powered to rotate counter to each other at a dynamic interface 115 between the brush and the blade carrier that provides an upward motion to lift plant material into engagement with the dynamic interface 115 between the brush and blade carrier. In another embodiment, the brush and blade carrier rotate in the same direction. Relative speed of rotation of both the blade carrier and the brush can be variable. Multiple helical directions of the brush in relation to the blade carrier blade directions are contemplated.

FIG. 2a is a diagrammatical end view of the brush 110 and blade carrier 120 according to one embodiment. In this embodiment, the brush 110 and blade carrier 120 are also arranged such that tangents AT, BT of downward extending radil AR, BR of each respective outer cylindrical diameter are approximately level with each other. In other words, a bottom of the brush is approximately level with a bottom of the blade carrier. This allows the dynamic interface 115 to operate at very low levels, expanding the turfgrass height of cut to which the apparatus 100 can operate and be effective. For example, the elevation device can be adjusted so that the brush tangent BT and blade carrier tangent CT are below the height of plants to be treated, almost reaching or, in some cases, reaching the ground. This can potentially expand the types of turfgrass where the apparatus 100 can be used (warm-season grasses, cool-season grasses maintained less than 1″ height of cut or golf course fairways, etc.). The relative spacing also enables the brush and blade carrier to work together to pull plant material into the brush/blade carrier dynamic interface 115.

FIG. 2b is a diagrammatical end view of the brush 110 and blade carrier 120 according to another embodiment. In this embodiment, the brush 110 and blade carrier 120 are also arranged such that blade carrier tangent CT is lower than the brush tangent BT. In other words, a bottom of the blade carrier is lower than a bottom of the brush.

Unlike in U.S. Pat. Nos. 9,648,863 and 10,194,649, no fixed, grooved baseblade is included. This reduces potential damage to desirable plants or crops. It also allows for an improved spatial relationship between the brush and the blade carrier relative to the ground and plants to be treated.

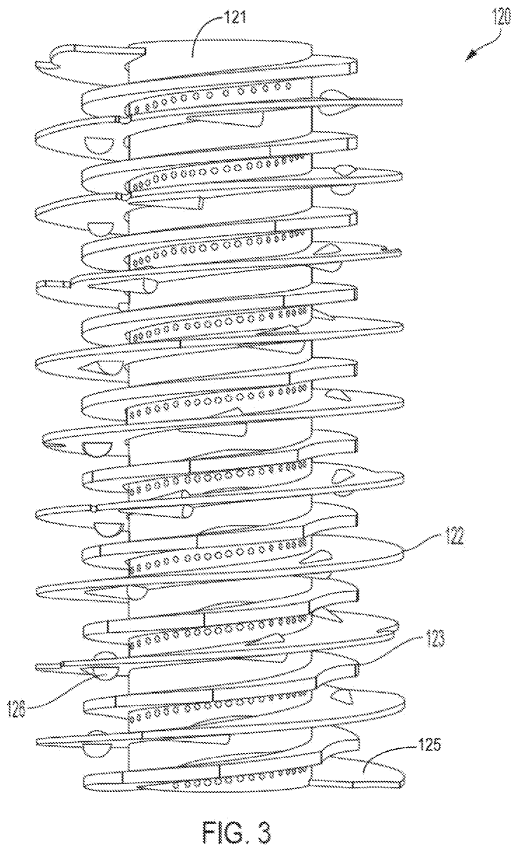

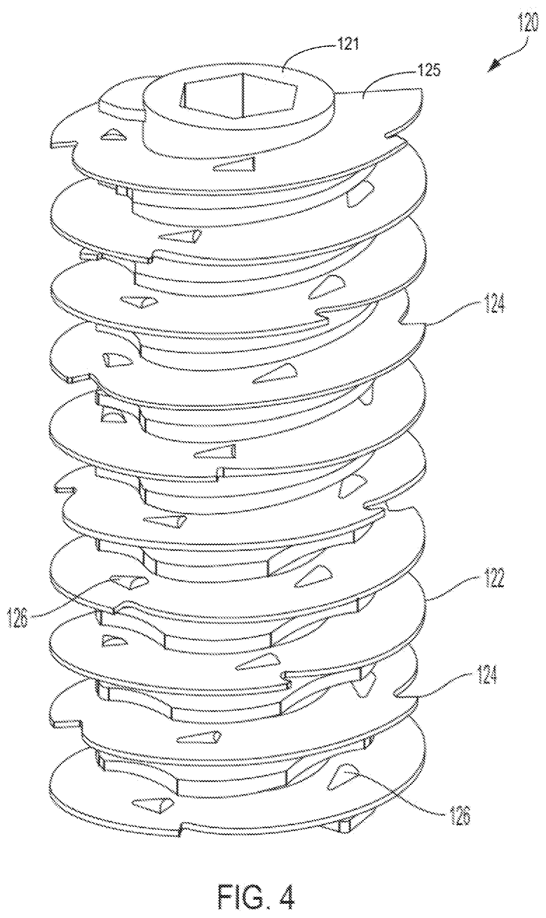

In more detail with reference to FIGS. 3 and 4, in some embodiments the blade carrier 120 is an auger-type carrier comprising one or more rotating helical screw blades 122 disposed on a lengthwise axle 121. Sidewalls 125 of the auger blades 122 and/or the axle 121 of the blade carrier between sidewalls 125 interact with the bristles of the brush to grab plant material. Notches/barbs/bumps/indentations may be located directly on the axle 121 to work with the bristles of the brush to grab unwanted plant material. The blade carrier rotation provides an upward and lateral force to assist with undesirable plant material removal or damage. In some examples, the auger blades may have hooks or other surface irregularities 124 disposed on the outer circumference of blade or blades. The hooks have been found to increase efficacy on annual grassy weeds such as crabgrass. The hooks also lift plant material into brush/blade dynamic interface 115. Finally, the hooks assist with blade 122 penetration into mixed stand (turfgrass and weeds)

In some examples, the auger blades 122 have burrs/barbs 126 on their sides. The burrs/barbs help grab unwanted plant material and lift the plant material into engagement with the brush/blade dynamic interface 115. While hooks/discontinuities 124 and burrs/barbs 126 are illustrated, a person of ordinary skill in the art will appreciate that other features on the axle 121 and blades 122 may be provided to enhance the dynamic interface 115 to engage weeds or other undesirable plants.

Features such as hooks 124 and burrs/barbs 126 may be provided, for example, every 120 degrees of rotation. Greater or fewer such features may be provided without departing from the scope of the invention.

In some examples, the blade carrier 120 includes alternating low and high (Major/Minor) auger blades 122, 123 where the minor blades 123 have a smaller cylindrical diameter than major blades 122. This allows the aggressiveness of the dynamic interface 115 action to be adjustable. Adjusting the proximity of the brush and blade carrier enables the depth of penetration of the bristles with respect to the blades 122, 123 of the blade carrier 120. By adjusting the distance of the brush from the blade carrier or blade carrier from the brush, the spacing between the blades of the blade carrier can move from 4 mm to 8 mm very quickly and without changing the blade carrier. At a closer distance, the brush 120 engages both major and minor auger blades 122, 123. At a farther distance, the brush may engage the major blades 122 alone, reducing dynamic interface 115 action on the plants.

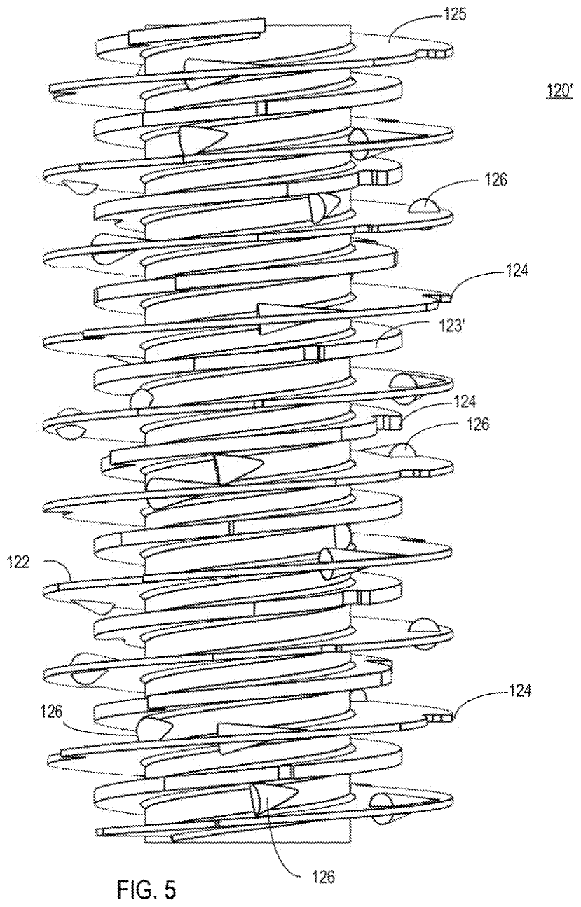

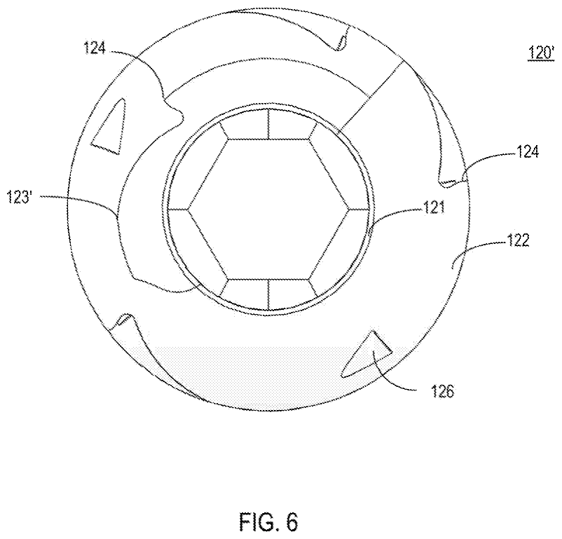

With reference to FIGS. 5 and 6, in some embodiments a blade carrier 120′ is employed in combination with the brush 110 as described above. The description above with respect to blade carrier 120′, including its use in the apparatus 100 and descriptions of components having common reference characters is incorporated by reference. In the example of FIGS. 5 and 6, the major blade 122 is included, along with a minor blade 123′. Minor blade 123′ includes discontinuities/hooks 124 as described above with respect to major blade 122. Additionally, barbs 126 are include on the axle of blade carrier 120′.

| In some embodiments, auger 120 and/or auger 120′ are coated with materials to enhance the blades grip on plant material. In one example, elastomers and/or rubber are disposed on the auger 120, 120′. The elastomers may be textured to improve performance.

In some embodiments, vertical cutting blades are included. The vertical cutting blades are layered in diameter than the augers blades to engage with prostrate weeds. Brush bristles may be absent in locations where a cutting blade is located. Non-cutting free wheel discs may also be included on the auger.

In some examples, the brush and auger are arranged such that the tangent CT of a downward extending radius CR of an outer diameter of the major blades 122 is approximately level with a tangent BT of a downward extending radius BR of the outer diameter of the brush. In some examples, the brush and auger are arranged such that the tangent of a downward extending radius of an outer diameter of the minor blades 123 is approximately level with the tangent BT of the downward extending radius BR of the outer diameter of the brush. Various placement positions of the auger with respect to the brush are contemplated to maximize the weed control efficacy depending on the crop and target weed species. For example, the tangents CT, BT of the downward extending radii CR, BR do not have to be exactly level if it is desired to have the brush and/or auger more closely engage plants near the surface of the area being treated.

In some examples, the auger includes vertically-oriented cutting discs, such a serrated discs. The serrations may be optimized for selective cutting of undesirable plants. In some embodiments, one or more augers are used without the brush or without vertical oriented cutting discs.

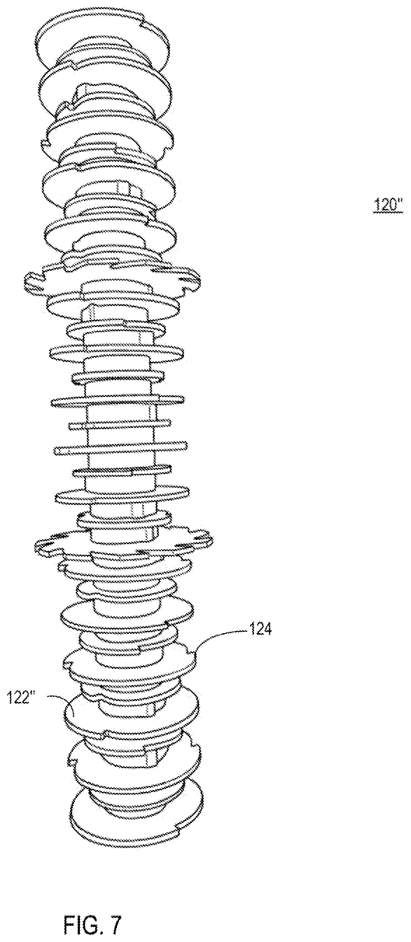

Referring to FIG. 7, in some examples, the helical-bladed auger-type blade carrier 120, 120′ is replaced or combined with a non-helical blade carrier 120″, such as a roller having a plurality of discs 122″ extending radially from a longitudinal axis of the blade carrier, A plane of each disc is substantially perpendicular to a lengthwise dimension of the roller. As with the example of the helical-bladed blade carrier 120, the sides of the discs engage the bristles of the brush in a dynamic interface. In some embodiments, the sides of the discs may have barbs as described above. In some embodiments, hooks 124 are deposed on the outer edges of the discs 122″ disc. Discs having different diameters may be included. The roller may be adjustable with respect to the brush to allow for adjustability of the aggressiveness of the apparatus.

The cylindrical brush 110 may be comprised of a plurality of separate rows. In the example illustrated in FIGS. 1-2, four rows 112 of brushes are used, each being installed outwardly from an axle to form a helix. Multiple directions of the helix of the brush with respect to the direction of twist on the auger blades 122 or discs 122″ are contemplated. Other numbers of rows may also be used with appropriate adjustments in the amount of twist on each row of brushes. Each row 112 can be comprised of a plurality of nylon bristles 111 each being approximately 1.5 mm diameter and having a 5 cm pile height. Differing pile heights may also be included.

In one illustrated example, bristles 111 are the same size, however, bristles of varying diameters may be included in brush 110. Bristle tips may be cut or rounded.

To further optimize the level of mechanical wear, the bristles may be smooth, textured or micro notched in the vertical or horizontal plane. In cases where weeds are especially hardy, metal blades or bristles may also be included on the brush 110. The blades may be shorter than the bristles, and the bristles would help bring the weeds into engagement with the base blade. While a plurality of staples of flexible bristles are a preferred example of a brush, the terms “brush” and “bristles” as used herein may also include any protrusions (e.g., tines, nubs) configured to impart selective tearing and/or bruising of leaf tissue.

The rows 112 are mounted on a shaft 113, which is supported by bearings on either end of apparatus 100. The rows 112 of the bristles 111 can be configured in a helicoid (a spiral shape around an axis or cylinder). The arrangement of the bristles 111 and rows 112 allow vegetation or plant material to enter the apparatus 100 and be subjected to the rotating bristles 111.

The bristles 111 and auger blades 122 or nonhelical discs 122″ both rotate to draw plant material into the dynamic interface 115 between the brush 110 and the blade carrier 120. Cooperating motion between the bristles 111 and the auger blades 122 cause the bristles and blades to grasp the undesirable plants and completely remove the plants from the ground (including the roots), 2) increase pressure on the leaf tissue/stem to promote tearing and bruising from bristle action and/or 3) completely remove the leaves of undesirable plants from the stem. Repeated applications at key points during the growing season exhausts the carbohydrate reserves of the undesirable plants, reducing plant competitiveness or leading to plant death. The blade carrier 120 and brush 110 are designed to not severely damage desirable crops, such as turfgrasses.

This apparatus can have multiple configurations to implement this method of weed control. Configuration examples are as follows; Stand-alone configurations include self-propelled walk-behind and ride-on units. The apparatus 100 can be used concurrently with a mower (i.e. two separate pieces of equipment operated independently) (not shown) or as an integrated part configured as a mower attachment, mounted in front, mid-section or rear of an existing mower. This includes ganged units, self-powered pull-behind units, and power take off driven, three-point hitch mounted or pull-type units for tractors. Alternatively, the integrated part can be designed integral as part of the mower or mower deck. Apparatus 100 may also be configured as an attachment to a non-mowing tractor or multipurpose power unit.

In some embodiments, the frame of the apparatus is configured to hold the cylindrical, brush 110 and blade carrier 120 enabling the brush 110 and bristles 111 to rotate and interact with the blades 122 of the rotating blade carrier 120 so as to impart wear on plant material, such as weeds and turfgrasses. In one example of the invention, the brush rotates. A belt driven by a power take off of a mower or dedicated weed removal unit may drive a pulley which is attached to the shaft of the brush. Another pulley and another belt may drive the blade carrier. Pulley sizes may be selected to achieve a desired rotational speed for the brush and blade carrier.

In another example, the shafts of the brush and blade carrier are driven hydraulically. The shaft and blade carrier may also be driven by wheels through a gearset as is known with reel-type mowers.

A prototype has been developed, and results from trials show that routine use on established turfgrass stands creates an environment favorable for obtaining results of desirable turfgrasses stands and detrimental to the most troublesome weed species in cool-season turfgrasses. Accordingly, the method of the present invention creates an environment where turfgrasses are able to persist and where weeds are not able to persist.

More specifically, once the leaf tissue of the weed species is damaged its ability to absorb the suns energy to produce carbohydrates through the process of photosynthesis is greatly reduced or eliminated. As the apparatus 100 of the present invention is used, the weed leaf tissue is damaged or removed with repeated and regular use. The weed will need to rely on carbohydrate reserves in the root system for recovery and growth. The competitiveness of the weed will be reduced. If this reserve supply is exhausted and defoliation continues plant death will occur.

Thus, according to the above description, the present inventive concept may be implemented in a number of ways. In one example, an apparatus for applying a desired amount of mechanical abrasion to plants and providing selective tearing, cutting, pulling and or removal of plants comprises:
a. an blade carrier rotatably attached to the apparatus and having a first longitudinal axis, the blade carrier further comprising one or more blades disposed around the first longitudinal axis and defining a first cylindrical diameter;
b. a brush rotatably attached to the apparatus and having a second longitudinal axis, the brush further comprising a plurality of bristles extending outwardly from the second longitudinal axis and defining a second cylindrical diameter, the brush being attached to the apparatus such that the second longitudinal axis is substantially parallel to the first longitudinal axis and; and
c. an elevation device for maintaining the blade carrier and brush at a height over a surface to engage desirable and undesirable plants;
   wherein brush and blade carrier are also arranged such that the bristles of the brush engage the blades of the blade carrier in a dynamic interface, and the blade carrier and the brush are approximately equally spaced from the surface.

The apparatus as above, wherein the one or more blades are helical.

The apparatus as above, wherein the one or more blades are discs.

The apparatus as above, wherein the blade carrier and brush are positional relative to each other such that the tangents of downward extending radii of each of the first and second cylindrical diameters are approximately level with each other. In other examples, the tangents are not level with each other, but the blade carrier and brush are substantially in a side-by-side relationship adjacent to the surface being treated.

The apparatus as above, wherein the blade carrier and the brush are powered to rotate in opposite directions.

The apparatus as above, wherein a spacing between the brush and blade carrier is adjustable.

The apparatus as above, wherein the blade carrier further comprises a first helical blade defining the first cylindrical diameter and a second helical blade defining a third cylindrical diameter, wherein the first and third cylindrical diameters are different.

The apparatus as above, wherein the blade carrier blade further comprises hooks on an outer circumference of the blades.

The apparatus as above, wherein the one or more blade further comprises burrs/barbs on the sides of the blade and the bristles of the brush engage the burrs/barbs.

The apparatus as above, where the dynamic interface does not have any fixed components for pulling, tearing, or otherwise damaging undesirable plants or weed.

While certain configurations of structures have been illustrated for the purposes of presenting the basic structures of the present invention, one of ordinary skill in the art will appreciate that other variations are possible which would still fall within the scope of the appended claims. For example, while the illustrated embodiment shows the brush ahead of the blade carrier in the direction of travel, the relative positions may be reversed. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for providing selective tearing, pulling and or removal of plants comprising:
a. a blade carrier rotatably attached to the apparatus and having a first longitudinal axis, the blade carrier further comprising one or more blades disposed around the first longitudinal axis, extending radially therefrom and defining a first cylindrical diameter;
b. a brush rotatably attached to the apparatus and having a second longitudinal axis, the brush further comprising a plurality of bristles extending outwardly from the second longitudinal axis and defining a second cylindrical diameter, the brush being attached to the apparatus such that the second longitudinal axis is substantially parallel to the first longitudinal axis; and
c. an elevation device for maintaining the blade carrier and brush at a height over a surface to engage desirable and undesirable plants;
wherein brush and blade carrier are also arranged such that the bristles of the brush engage the blades of the blade carrier in a dynamic interface, and the blade carrier and the brush are approximately equally spaced from the surface.

2. The apparatus of claim 1, wherein the one or more blades on the blade carrier are helical.

3. The apparatus of claim 1, wherein the one or more blades on the blade carrier are discs.

4. The apparatus of claim 1, wherein the blade carrier and brush are positioned such that a first tangent of a first downward extending radius of the first cylindrical diameter is approximately level with a second tangent of a second downward extending radius of the second cylindrical diameter.

5. The apparatus of claim 1, wherein the blade carrier and brush are positioned such that a first tangent of a first downward extending radius of the first cylindrical diameter is lower than a second tangent of a second downward extending radius of the second cylindrical diameter.

6. The apparatus of claim 1, wherein the blade carrier and the brush are powered to rotate in opposite directions.

7. The apparatus of claim 1, wherein a spacing between the brush and the blade carrier is adjustable to increase or decrease the size of the dynamic interface.

8. The apparatus of claim 1, wherein the blade carrier further comprises a first helical blade defining the first cylindrical diameter and a second helical blade defining a third cylindrical diameter, wherein the first and third cylindrical diameters are different.

9. The apparatus of claim 7, wherein a spacing between the brush and the blade carrier is adjustable such that the dynamic interface selectably configurable in a range to comprise from the brush and first helical blade only to the brush and first and second helical blades.

10. The apparatus of claim 1, wherein the one or more blades further comprises hooks on an outer circumference of the one or more blades.

11. The apparatus of claim 1, wherein the blade carrier blade further comprises burrs/barbs on the sides of the blade and the bristles of the brush engage the burrs/barbs.

12. The apparatus of claim 1, where the dynamic interface does not have any fixed components that directly engage in pulling, tearing, or otherwise damaging undesirable plants.

13. The apparatus of claim 1, wherein a rotational speed of the blade carrier is different than a rotational speed of the brush.

14. The apparatus of claim 1, wherein the blade carrier and the brush are powered to rotate in the same direction.
